(19) United States
(12) Patent Application Publication
(10) Pub. No.: US 2009/0050696 A1
(43) Pub. Date: Feb. 26, 2009

(54) System and method for valid period control

(76) Inventor: Ching Feng Wang, Tainan City (TW)

Correspondence Address: Raymond Sun, 12420 Woodhall Way, Tustin, CA, 92782, US

(21) Appl. No.: 12/221,373

(22) Filed: Aug. 1, 2008

(30) Foreign Application Priority Data
Aug. 23, 2007 (TW) 96131174

(51) Int. Cl. G06K 7/01

(52) U.S. Cl. 235/382

(57) ABSTRACT

A system for valid period control, comprising: a user device and a paid service server. The user device comprises a device identification code; the paid service server accepts the device identification code; assigns an expiry date according to the device identification code, and then encrypts and sends the device identification code and the expiry date back to the user device. The paid service server of the system for valid period control may be located at a provider of paid services for securities, thus allowing the provider of paid services for securities to manage expiry dates of users independently, and does not require assistance from a securities information service provider.

### BACKGROUND OF INVENTION

1. Field of the Invention

The invention relates to a system and method for valid period control, and particularly to a system and method for managing expiry dates applied to providers of paid services for securities, which generates expiry dates that correspond to identification codes of users, and sends the expiry dates to the users via text messaging.

2. Description of the Prior Art

With the rapid advancement of information technologies, people's demand for access to information and communication instantly and conveniently has grown exponentially, and a variety of wireless mobile communication devices are constantly introduced in order to meet such demands. For example, devices that comprise various cell phones, smart phones, stock managers, and PDAs (Personal Digital Assistant) with the function of mobile communication.

Apart from hardware such as the aforesaid wireless mobile communication devices, a diversity of software that may be used in combination with the hardware are also constantly introduced, so as to allow users to manage financial businesses, work, entertain themselves, or obtain information instantly and conveniently at any time and anywhere. For instance, the use of wireless mobile communication devices for carrying out electronic transactions related to securities or futures. For the wireless mobile communication devices used for carrying out electronic transactions related to securities or futures, paid services from each provider of paid services for securities are provided in addition to electronic ordering; for example, such paid services may comprise further analysis of securities information from each investment consulting firm to users. Generally, users of a securities information service provider may carry out electronic ordering via the securities information service provider, but the users need to pay in order to use additional paid services provided by providers of paid services for securities, and payment from the users allows them to use the paid services within a limited time. Therefore, the investment consulting firms require an easy-to-use system for effectively managing expiry dates of the users.

There are currently many methods available for managing expiry dates in the context of software; the most common methods comprise the use of connectors that may be connected to computers and serve as auxiliary tools for managing expiry dates, such as USB connectors, parallel port connectors, and serial port connectors. When users execute the software in computers, the connectors connected to the computers are checked in the first place to ensure the users in question are the legitimate users, and different expiry dates may be set for each of the connectors if necessary. However, such methods require the use of hardware in combination, and the connectors may not be applicable to all user devices that require the management of expiry dates, such as the case with the PDAs.

Another common method is to employ a central server via the Internet to check whether the users in question are the legitimate users or not. However, this method require the user devices to be connected to the Internet, and if the user devices cannot be connected to the Internet, or are located at somewhere beyond the reach of the Internet, the expiry dates may not be checked, and the related software may not be executed as a consequence.

### SUMMARY OF INVENTION

A primary objective of the invention is to propose a system and a method for valid period control, which employs a device identification code of a user device to assign an expiry date, and then encrypts and sends the device identification code and the expiry date back to the user device. Therefore, the provider of paid services for securities may manage expiry dates of users independently, and does not require assistance from a securities information service provider.

In order to achieve this objective, the present invention discloses a system for valid period control, which comprises: a user device and a paid service server. The user device comprises a device identification code; the paid service server accepts the device identification code; assigns an expiry date according to the device identification code, and then encrypts and sends the device identification code and the expiry date back to the user device. The paid service server of the system for valid period control may be located at a provider of paid services for securities, thus allowing the provider of paid services for securities to manage expiry dates of users independently, and does not require assistance from a securities information service provider.

In a preferred embodiment, the system for valid period control in accordance with the present invention further comprises a main server. The main server is for accepting the device identification code provided by an external user, and ensuring the user is authorized to log into the main server before accepting the device identification code. The paid service server further comprises a database for storing a plurality of links between the device identification code and the expiry date, so as to confirm the expiry date of the device identification code after accepting the device identification code. The paid service server sends the encrypted device identification code and the expiry date in a text message via a wireless mobile communication system, and comprises a caller identification code within the text message. When the system for valid period control is applied to a paid service for securities, the main server is owned by a securities information service provider, and the paid service server is owned by a provider of paid services for securities; the securities information service provider and the provider of paid services for securities are organizations independent from each other.

In order to achieve the aforementioned objective, the present invention also discloses a method for valid period control, which comprises the following steps:

accepting a device identification code provided by an external user device; and

assigning an expiry date according to the device identification code, and then encrypting and sending the device identification code and the expiry date back to the user device.

In a preferred embodiment, the step of encrypting the device identification code and the expiry date further comprises the following steps:

obtaining a first outputted value by subjecting the device identification code to a SHA-256 (Secure Hash Standard-256) algorithm;

using the first outputted value as an encryption key for encrypting the device identification code and the expiry date via an Advanced Encryption Standard (AES).

In a preferred embodiment, the step of decrypting the device identification code and the expiry date via the user device further comprises the following steps:

obtaining the device identification code from the user device, and subjecting the device identification code to a SHA-256 algorithm to obtain a second outputted value;

using the second outputted value as a decryption key for decrypting the device identification code and the expiry date via an Advanced Encryption Standard (AES).

### BRIEF DESCRIPTION OF THE DRAWINGS

The structure and the technical means adopted by the present invention to achieve the above and other objectives can be best understood by referring to the following detailed description of the preferred embodiments and the accompanying diagrams, wherein:

FIG. 1 is a schematic view that shows a system for valid period control according to a preferred embodiment of the invention.

FIG. 2 is a block view that shows hardware for a user device in the method for valid period control according to a preferred embodiment of the invention.

FIG. 3 is a block view that shows a user device in the method for valid period control according to a preferred embodiment of the invention.

FIG. 4 is a flow chart that shows a method for valid period control according to a preferred embodiment of the invention.

FIG. 5 is a flow chart that shows a process of encrypting in the method for valid period control according to a preferred embodiment of the invention.

FIG. 6 is a flow chart that shows a process of decrypting and checking in a user device in the method for valid period control according to a preferred embodiment of the invention.

### DETAILED DESCRIPTION OF PREFERRED EMBODIMENTS

In the system and the method for valid period control of the invention, an expiry date is assigned according to a device identification code of a user device, then the device identification code and the expiry date are encrypted and sent back to the user device. The system for valid period control of the invention comprises: a user device and a paid service server; wherein the user device comprises a device identification code, and the paid service server accepts the device identification code, then assigns an expiry date according to the device identification code, followed by encrypting and sending the device identification code and the expiry date back to the user device. The paid service server also uses a text message for sending the encrypted device identification code and expiry date via a wireless mobile communication system. Therefore, a provider of paid services for securities may manage expiry dates of users independently by using the system for valid period control of the invention, and does not require assistance from a securities information service provider.

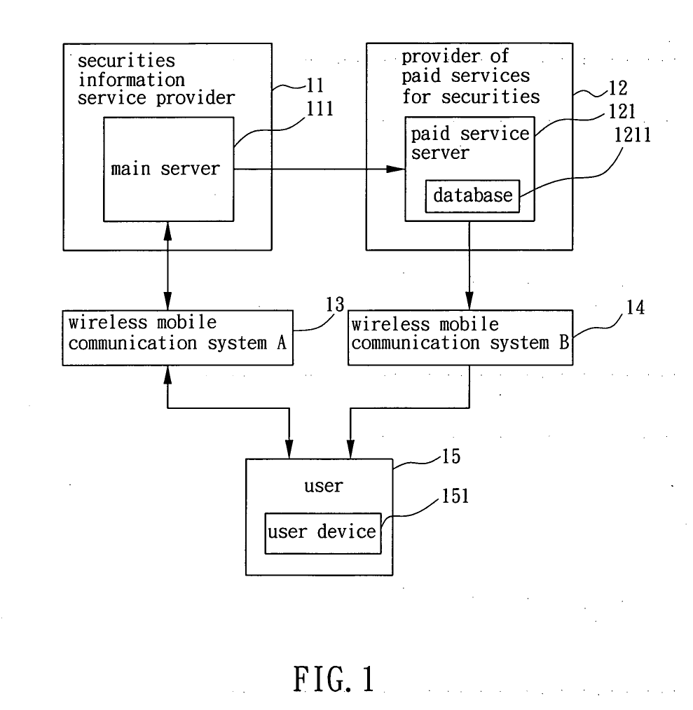

Referring to FIG. 1, which is a schematic view that shows a system for valid period control according to a preferred embodiment of the invention. Fundamentally, the system for valid period control according to the invention is based on a wireless communication environment comprised of a wireless mobile communication system A 13 (which may comprise but not limited to: GMS, CDMA, GPRS, and 3G) and a wireless mobile communication system B 14, and may allow an external user 15 to establish connections thereto (by using a handheld wireless mobile communication device, for instance). In this embodiment, a user device 151 used by the user 15 may be a smart phone, a handheld stock manager, or a PDA with mobile communication that can download data wirelessly; the user device 151 may connect to a main server 111 of the invention via the wireless mobile communication system A 13, and also connect to a paid service server 121 of the invention via the wireless mobile communication system B 14, so that wireless connections may be established between the main server 111, the paid service server 121, and the user device 151 to allow for data transmission. Wherein the main server 111 is owned by a securities information service provider 11, the paid service server 121 is owned by a provider of paid services for securities 12; the securities information service provider 11 and the provider of paid services for securities 12 are organizations independent from each other. Because different organizations may use different wireless mobile communication systems, the wireless mobile communication system A 13 and the wireless mobile communication system B 14 may be services provided by different providers of wireless mobile communication system. In addition, the wireless mobile communication system A 13 and the wireless mobile communication system B 14 may be of the same systems such as GMS, GPRS, and 3G; or the wireless mobile communication system A 13 may be a WiFi/WiMax system while the wireless mobile communication system B 14 may be a GSM, GPRS, or 3G system.

In this embodiment, the system for valid period control comprises: a main server 111, a paid service server 121, and a user device 151. Moreover, the paid service server 121 further comprises: a database 1211. The main server 111 is located within the securities information service provider 11, and receives a device identification code sent from a user device 151 of a user 15 via the wireless mobile communication system A 13. Though the user device 151 has a unique International Mobile Subscriber Identity (IMSI) under either the GSM/GPRS/WCDMA system, the user device 151 still needs a Subscriber Identity Module (SIM) under the GSM/GPRS/WCDMA system in order to use the Internet; a hardware identification code of the SIM is used as the device identification code in this case. Before the main server 111 accepts the device identification code, the user must be confirmed to be a legitimate user of the securities information service provider, only then can the user be authorized to log into the main server 111. Because paid users of the provider of paid services for securities 12 have to obtain paid services via the securities information service provider 11, the paid users are usually subscribed to the securities information service provider 11 as well, thus identities of the paid users has been verified before logging into the securities information service provider 11, and if the user 15 has already logged into the securities information service provider 11 when he initiates the service of valid period control, it would only be necessary to transmit the device identification code directly. Whether the user 15 has already logged into the securities information service provider 11 or not, the main server 111 of the securities information service provider 11 may assist the user to complete the process of verifying user identity, so as to reduce the work load on the paid service server 121. After the main server 111 has received the device identification code provided by the user 15, the main server 111 may transmit the device identification code to the paid service server 121 via a communication network (which may comprise but not limited to: wireless communication systems like GSM, CDMA, GPRS, PHS, and WLAN; or wired communication systems like ADSL). The paid service server 121 then searches for an expiry date linked to the device identification code in the database 1211; encrypts and attaches the device identification code and the expiry date with a caller identification code, followed by sending the device identification code and the expiry date as a text message to the user device 151 via a wireless mobile communication system (which may comprise but not limited to: GPRS and 3G). When the user device 151 receives the text message, the caller identification code in the text message is firstly checked to see if the caller identification code had indeed originated from the paid service server 121, if the caller identification code is not from the paid service server 121, the text message would not be further processed, which prevents the user from sending the text message containing the expiry date to other users and allows the other users to have a chance of using the paid services. When the caller identification code is verified to be from the paid service server 121, the device identification code and the expiry date are decrypted, and the device identification code is further checked. If the device identification code differs from the device identification code of the user device 151, the paid services would not be initiated. When the device identification code is confirmed to be identical to the device identification code of the user device 151, the expiry date is checked. If the expiry date does not comprise a working date of the user device 151, the paid services would not be initiated. When the expiry date is confirmed to contain the working date, the paid services would be initiated. The working date represents an actual date from which the user device 151 begins to use the paid services, and the user device 151 may obtain a standard time from the Internet to use as the working date, or the user device 151 may use a data date derived from instant data received thereof (for example, real time market data or K-line data required in the programs used by the investment & consulting firms in the user device 151) as the working date.

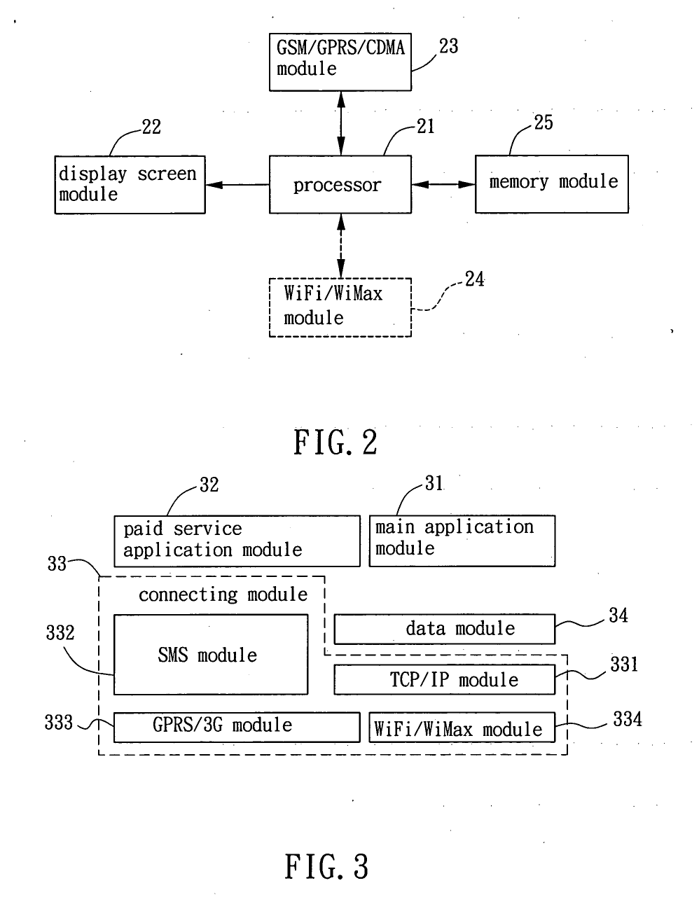

Referring to FIG. 2, which is a block view that shows hardware for a user device in the method for valid period control according to a preferred embodiment of the invention; the user device 151 comprises: a processor 21, a display screen module 22, a GSM/GPRS/CDMA module 23, a WiFi/WiMax module 24, and a memory module 25. When the securities information service provider 11 carries out communications, the processor 21 may send a device identification code to the securities information service provider 11, and then the securities information service provider 11 sends the device identification code to a provider of paid services for securities 12. When the provider of paid services for securities 12 verifies the legitimacy of the device identification code, the processor 21 may receive an expiry date from the provider of paid services for securities 12, and then initiates a paid service provided by the provider of paid services for securities 12 after verifying and confirming the effectiveness of the expiry date; wherein the paid service may be displayed on the display screen module 22 of the user device 151. The paid service and the device identification code are sent via the GSM/GPRS/CDMA module 23 and the WiFi/WiMax module 24, and relevant data may be stored into the memory module 25. The reason for showing the WiFi/WiMax module 24 in dotted lines is because if the wireless mobile communication system A 13 and the wireless mobile communication system B 14 were of an identical communication system that could be the GSM/GPRS/CDMA system, the user device 151 would not require the WiFi/WiMax module 24; whereas if the wireless mobile communication system A 13 was of the WiFi/WiMax system, the user device 151 must be equipped with the WiFi/WiMax module 24.

Referring to FIG. 3, which is a block view that shows a user device in the method for valid period control according to a preferred embodiment of the invention; the user device comprises: a main application module 31, a paid service application module 32, a connecting module 33, and a data module 34. Furthermore, the connecting module 33 further comprises: a TCP/IP module 331, a SMS module 332, a GPRS/3G module 333, and a WiFi/WiMax module 334; wherein the WiFi/WiMax module 334 is shown in dotted lines because if the wireless mobile communication system A 13 and the wireless mobile communication system B 14 were of an identical communication system that could be the GSM/GPRS/CDMA system, the user device would not require the WiFi/WiMax module 334; whereas if the wireless mobile communication system A 13 was of the WiFi/WiMax system, the user device must be equipped with the WiFi/WiMax module 334. The main application module 31 is used to assist the user device 151 to log into the main server 111 of the securities information service provider 11, and transmit the device identification code to the main server 111. The paid service application module 32 is used to receive and decrypt a text message containing an expiry date sent by the paid service server 121 of the provider of paid services for securities 12. The connecting module 33 is used to connect to the main server 111 of the securities information service provider 11, as well as to the paid service server 121 of the provider of paid services for securities 12, and carry out communications via a communication protocol supported by the main server 111 and the paid service server 121. Wherein, the connecting module 33 may use at least one of following communication protocols for carrying out communications: GPRS, 3G, Wireless Fidelity (WiFi), and Worldwide Interoperability for Microwave Access (WiMax). The data module 34 is used to store data of paid services and data of main applications received by the user device 151. For instance, when the user device 151 is checking whether the caller identification code in the text message comes from the paid service server 121 or not, a caller identification code corresponding to a paid service server 121 stored in the data of paid services is used for comparing with the caller identification code in the text message.

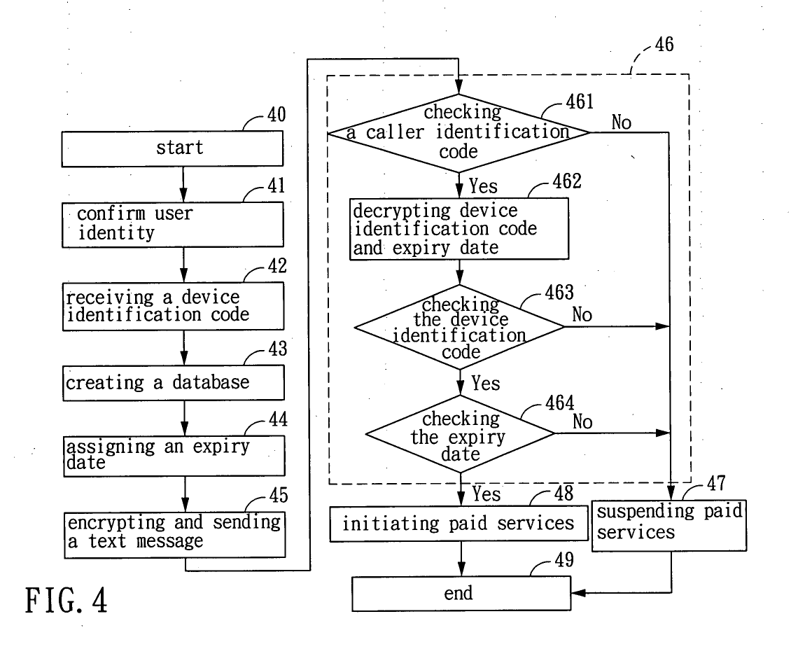

Referring to FIG. 4, which is a flow chart that shows a method for valid period control according to a preferred embodiment of the invention; comprising:

Step 40: starting the service for managing expiry dates (i.e., valid period control).

Step 41: checking if an identity of an external user is legitimate.

Step 42: accepting a device identification code provided by the user.

Step 43: creating a database for storing a plurality of links between the device identification code and an expiry date.

Step 44: assigning the expiry date according to the device identification code.

Step 45: after encrypting the device identification code and the expiry date, sending the encrypted device identification code and expiry date as a text message to the user via a wireless mobile communication system (which may comprise but not limited to: GPRS and 3G), and attach a caller identification code to the text message.

Step 46: decrypting and checking the text message via a user device of the user. The step 46 may be further divided into four sub-steps that comprises:

Step 461: checking if the caller identification code of the text message has indeed come from the paid service server; if “no”, the step 47 is executed; if “yes”, the step 462 is executed.

Step 462: decrypting the device identification code and the expiry date in the text message.

Step 463: checking if the device identification code in the text message is identical to the device identification code of the user device; if “no”, the step 47 is executed; if “yes”, the step 464 is executed.

Step 464: checking if the expiry date in the text message comprises a working date of the user device; if “no”, the step 47 is executed; if “yes”, the step 48 is executed; wherein the working date represents an actual date from which the user device has begun to use a paid service, and the user device may obtain a standard time to serve as the working date via the Internet, or the user device may use a data date derived from instant data received thereof (for example, real time market data or K-line data required in the programs used by the investment & consulting firms in the user device 151) as the working date.

Step 47: suspending the use of the paid services.

Step 48: initiating the paid services.

Step 49: ending the service for managing expiry dates (i.e., valid period control).

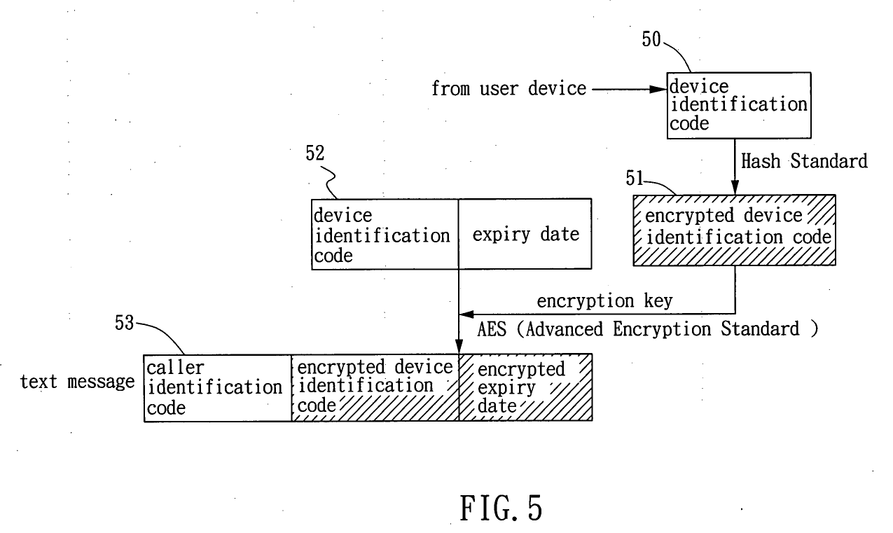

Referring to FIG. 5, which is a flow chart that shows a process of encrypting in the method for valid period control according to a preferred embodiment of the invention; comprising:

Step 50: accepting the device identification code provided by a user device, the device identification code is a hardware identification code of the user device, such as an identification code of a SIM card.

Step 51: obtaining a first outputted value (which is the encrypted device identification code) by subjecting the device identification code to a SHA-256 (Secure Hash Standard-256) algorithm.

Step 52: using the first outputted value as an encryption key for encrypting the device identification code and a corresponding expiry date via an Advanced Encryption Standard (AES).

Step 53: attaching a caller identification code to the encrypted device identification code and expiry date, and combining the caller identification code into a text message.

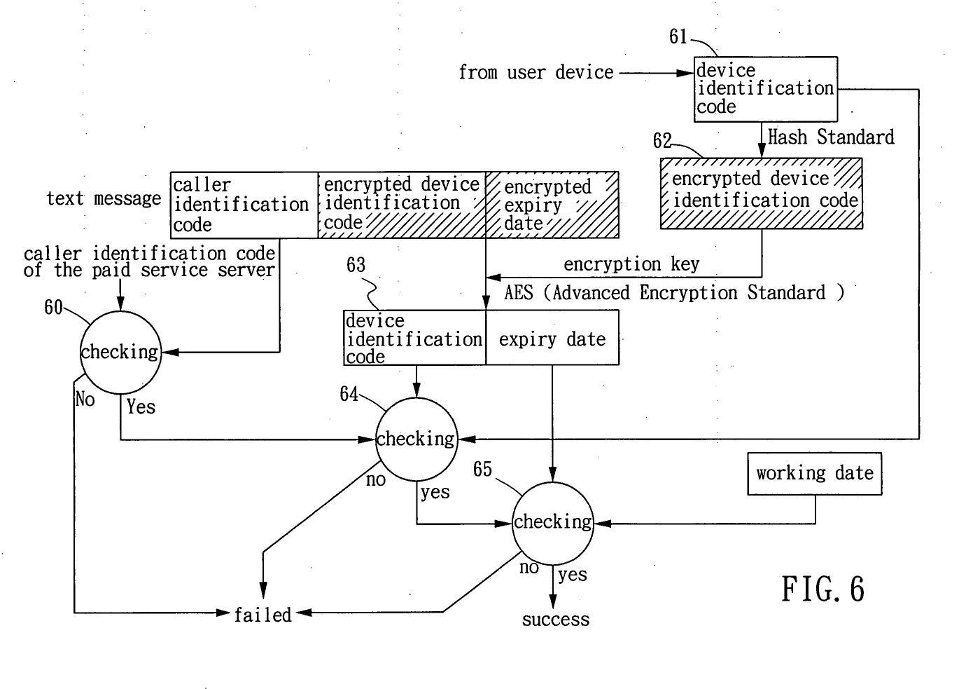

Referring to FIG. 6, which is a flow chart that shows a process of decrypting and checking in a user device in the method for valid period control according to a preferred; comprising:

Step 60: checking if the identification code in the text message has indeed come from a paid service server; if “no”, stopping the process of decrypting and checking, and sending a message that indicates the failure; if “yes”, the steps 61-64 are executed.

Step 61: obtaining a device identification code from the user device.

Step 62: obtaining a second outputted value (which is the encrypted device identification code) by subjecting the device identification code to a SHA-256 algorithm.

Step 63: using the second outputted value as a decryption key for decrypting the encrypted device identification code and expiry date via an Advanced Encryption Standard (AES).

Step 64: checking if the decrypted device identification code of the text message is identical to the device identification code of the user device; if “no”, stopping the process of decrypting and checking, and sending a message that indicates the failure; if “yes”, the step 65 is executed.

Step 65: checking if the decrypted expiry date in the text message comprises a working date of the user device; if “no”, stopping the process of decrypting and checking, and sending a message that indicates the failure; if “yes”, sending a message that indicates the process has succeed; wherein the working date represents an actual date from which the user device has begun to use a paid service, and the user device may obtain a standard time to serve as the working date via the Internet, or the user device may use a data date derived from instant data received thereof (for example, real time market data or K-line data required in the programs used by the investment & consulting firms in the user device 151) as the working date.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A system for valid period control, comprising:
a user device having a device identification code therein; and
a paid service server for accepting the device identification code, and assigning an expiry date according to the device identification code, then encrypting and sending the device identification code and the expiry date back to the user device.

2. The system for valid period control of claim 1, further comprising:
a main server for accepting the device identification code provided by an external user, and ensuring the user is authorized to log into the main server before accepting the device identification code.

3. The system for valid period control of claim 1, wherein the paid service server further comprises a database for storing a plurality of links between the device identification code and the expiry date, so as to confirm the expiry date of the device identification code after accepting the device identification code.

4. The system for valid period control of claim 1, wherein the paid service server sends the encrypted device identification code and the expiry date in a text message via a wireless mobile communication system, and comprises a caller identification code within the text message; wherein the wireless mobile communication system comprises one of following: GPRS and 3G; in which the device identification code is a hardware identification code of a Subscriber Identity Module (SIM).

5. The system for valid period control of claim 4, wherein when the user device receives the text message, the user device decrypts and checks the device identification code and the expiry date within the text message to following conditions: whether the caller identification code originates from the paid service server or not, whether the device identification code is identical to the device identification code of the user device or not, and whether the expiry date comprises a working date of the user device or not.

6. The system for valid period control of claim 5, wherein the working date of the user device uses one of following as a reference: the user device obtains a standard time via the Internet, and the user device obtains a data date from an instant data received thereof.

7. The system for valid period control of claim 2, wherein when the system for valid period control is applied to a paid service for securities, the main server is owned by a securities information service provider, and the paid service server is owned by a provider of paid services for securities; the securities information service provider and the provider of paid services for securities are organizations independent from each other.

8. The system for valid period control of claim 2, wherein the user device further comprises:
a main application module for assisting the user device to log into the main server, and sending the device identification code to the main server;
a paid service application module for receiving and decrypting the text message sent from the paid service server;
a connecting module for connecting to the main server of the system for valid period control and the paid service server, and carrying out communication via a communication protocol supported by the main server and the paid service server; and
a data module for storing a plurality of data received by the user device, wherein the plurality of data comprises at least one of following: data of paid services, and data of main application;
wherein the connecting module may use at least one of following communication protocols for carrying out communication: GPRS, 3G, WiFi, and WiMax;
the connecting module further comprises: a TCP/IP module, a SMS module, a GPRS/3G module, and a WiFi/WiMax module.

9. A method for valid period control, comprising:
accepting a device identification code provided by an external user device; and
assigning an expiry date according to the device identification code, and then encrypting and sending the device identification code and the expiry date back to the user device.

10. The method for valid period control of claim 9, wherein a further step of verifying whether an identity of the user device is legitimate is comprised prior to the step of accepting the device identification code provided by the user device.

11. The method for valid period control of claim 9, wherein a further step of creating a database is comprised prior to the step of assigning the expiry date; the database is for storing a plurality of links between the device identification code and the expiry date, so as to confirm the expiry date of the device identification code after accepting the device identification code.

12. The method for valid period control of claim 9, wherein the encrypted device identification code and the expiry date are sent as a text message via a wireless mobile communication system; the text message comprises a caller identification code; wherein the wireless mobile communication system comprises one of following: GPRS and 3G; in which the device identification code is a hardware identification code of a Subscriber Identity Module (SIM).

13. The method for valid period control of claim 12, wherein when the user device receives the text message, the user device decrypts and checks the device identification code and the expiry date within the text message to following conditions: whether the caller identification code originates from the paid service server or not, whether the device identification code is identical to the device identification code of the user device or not, and whether the expiry date comprises a working date of the user device or not.

14. The method for valid period control of claim 13, wherein the working date of the user device uses one of following as a reference: the user device obtains a standard time via the Internet, and the user device obtains a data date from an instant data received thereof.

15. The method for valid period control of claim 9, wherein when the method for valid period control is applied to a paid service for securities, a securities information service provider is employed to receive the device identification code from the user, and a provider of paid services for securities is employed to assign the expiry date according to the device identification code; wherein the securities information service provider and the provider of paid services for securities are organizations independent from each other.

16. The method for valid period control of claim 13, wherein the user device further comprises:
a main application module for assisting the user device to log into the main server, and sending the device identification code to the main server;
a paid service application module for receiving and decrypting the text message sent from the paid service server;
a connecting module for connecting to the main server of the system for valid period control and the paid service server, and carrying out communication via a communication protocol supported by the main server and the paid service server; and
a data module for storing a plurality of data received by the user device, wherein the plurality of data comprises at least one of following: data of paid services, and data of main application;
wherein the connecting module may use at least one of following communication protocols for carrying out communication: GPRS, 3G, WiFi, and WiMax;
the connecting module further comprises: a TCP/IP module, a SMS module, a GPRS/3G module, and a WiFi/WiMax module.

17. The method for valid period control of claim 9, wherein the step of encrypting the device identification code and the expiry date comprises:
obtaining a first outputted value by subjecting the device identification code to a SHA-256 (Secure Hash Standard-256) algorithm;
using the first outputted value as an encryption key for encrypting the device identification code and the expiry date via an Advanced Encryption Standard (AES).

18. The method for valid period control of claim 13, wherein the step of decrypting the device identification code and the expiry date via the user device comprises the following steps:
obtaining the device identification code from the user device, and subjecting the device identification code to a SHA-256 algorithm to obtain a second outputted value;
using the second outputted value as a decryption key for decrypting the device identification code and the expiry date via an Advanced Encryption Standard (AES).
